(19) United States
(12) Patent Application Publication
(10) Pub. No.: US 2017/0320718 A1
(43) Pub. Date: Nov. 9, 2017

(54) LIQUID DISTRIBUTION SYSTEM

(71) Applicant: Beyond Zero, Inc., Louisville, KY (US)

(72) Inventors: Jason S. SHERMAN, Louisville, KY (US); D. Paul HAVILAND, Louisville, KY (US)

(21) Appl. No.: 15/585,417

(22) Filed: May 3, 2017

Related U.S. Application Data
(60) Provisional application No. 62/331,173, filed on May 3, 2016.

(51) Int. Cl. B67D 1/00; B67D 1/08; C12G 3/14

(52) U.S. Cl. CPC B67D 1/0005; C12G 3/105; B67D 1/0857; B67D 1/0888

(57) ABSTRACT

A dispensing system for a liquid provides a liquid distributor having an inlet for receiving the liquid and outlet for dispensing the liquid into a pouring reservoir that is positioned to receive the liquid from the outlet of the liquid distributor. A sensor communicates with the liquid distributor and the pouring reservoir for determining a liquid fill level within the pouring reservoir.

### CROSS-REFERENCE TO RELATED APPLICATION

This application is related to and claims priority to U.S. Provisional Patent Application Ser. No. 62/331,173, filed May 3, 2016, entitled LIQUID DISTRIBUTION SYSTEM, the entirety of which is incorporated herein by reference.

### STATEMENT REGARDING FEDERALLY SPONSORED RESEARCH OR DEVELOPMENT

n/a

### TECHNICAL FIELD

The present invention relates to a system for fluid distribution. More particularly, the invention relates to delivering a specific volume of a beverage into a freezing mechanism to create portions of a frozen beverage.

### BACKGROUND

Freezing beverages, especially beverages containing sugar, alcohol, and/or other adulterated ingredients, is a technically challenging undertaking. A number of challenges are presented when creating “ice cubes,” i.e., frozen liquid, containing alcohol for beverages. For example, one of the greatest challenges is to quickly, efficiently, affordably and safely reduce alcohol to a temperature far colder than temperatures achieved by a typical machine for making ice. As “ice” is always made from water which is inexpensive, the complexity and efficiency of such machines is not a consideration. However, known water-ice machines are unsuitable for creating frozen ice containing sugar, alcohol, and/or other adulterated ingredients, on demand from various types of beverages, while minimizing waste in the process.

### SUMMARY

A dispensing system for a liquid is provided including a liquid distributor having an inlet for receiving the liquid and an outlet for dispensing the liquid. A pouring reservoir is positioned to receive the liquid from the outlet of the liquid distributor and a sensor is in communication with the liquid distributor and the pouring reservoir for determining a liquid fill level within the pouring reservoir.

In another aspect of this embodiment, the dispensing system includes a liquid reservoir in fluid communication with the inlet of the liquid distributor.

In another aspect of this embodiment, the liquid reservoir is a beverage bottle.

In another aspect of this embodiment, the dispensing system includes a tube having a first end that is connected to the inlet of the liquid distributor and a second end that is inserted into the beverage bottle.

In another aspect of this embodiment, the liquid distributor is responsive to the sensor to control an amount of liquid dispensed from the outlet of the liquid distributor.

In another aspect of this embodiment, the liquid distributor dispenses the liquid from the outlet in response to a predetermined condition and the liquid distributor stops dispensing the liquid from the outlet in response to a predetermined sensor input.

In another aspect of this embodiment, the dispensing system includes a positioning device for moving the pouring reservoir with respect to a reference plane.

In another aspect of this embodiment, the pouring reservoir comprises a plurality of chambers.

In another aspect of this embodiment, the plurality of chambers are connected by a liquid flow channel.

In another aspect of this embodiment, the outlet of the liquid distributor is positioned to dispense the liquid into the liquid flow channel.

In another aspect of this embodiment, the reference plane is a horizontal plane and the positioning device positions the pouring reservoir so that the liquid flow channel is parallel to the horizontal plane.

In another aspect of this embodiment, the dispensing system includes a freezing chamber disposed below the pouring reservoir.

In another aspect of this embodiment, the positioning device rotates the pouring reservoir with respect to the reference plane to cause the liquid to flow into the freezing chamber.

In another aspect of this embodiment, the sensor is a fill level indicator.

In another embodiment, the dispensing system for a liquid includes a liquid distributor having an outlet for dispensing the liquid and a pouring reservoir positioned to receive the liquid from the outlet of the liquid distributor. A sensor is in communication with the pouring reservoir for determining a liquid fill level within the plurality of chambers of the pouring reservoir and a positioning device is coupled to the pouring reservoir for rotating the pouring reservoir with respect to a reference plane.

In another aspect of this embodiment, the dispensing system includes an accelerometer for establishing the reference plane.

In another aspect of this embodiment, the liquid distributor dispenses the liquid from the outlet in response to a predetermined condition and the liquid distributor stops dispensing the liquid from the outlet in response to a predetermined sensor input.

In another aspect of this embodiment, the dispensing system includes a freezing chamber disposed below the pouring reservoir.

In another aspect of this embodiment, the positioning device is in communication with the pouring reservoir for rotating the pouring reservoir with respect to the reference plane to cause the liquid to flow into the freezing chamber.

In another embodiment, the dispensing system for a liquid includes a liquid distributor having an inlet for receiving the liquid and outlet for dispensing the liquid. A pouring reservoir includes a plurality of chambers connected by a liquid flow channel positioned to receive the liquid from the outlet of the liquid distributor. A sensor is in communication with the liquid distributor and the pouring reservoir for determining a liquid fill level within the pouring reservoir. A liquid reservoir is in fluid communication with the inlet of the liquid distributor. A tube is provided having a first end that is connected to the inlet of the liquid distributor and a second end that is inserted into the beverage bottle. The dispensing system also includes a positioning device for moving the pouring reservoir with respect to a horizontal reference plane. A freezing chamber is disposed below the pouring reservoir for receiving the liquid from the pouring reservoir when the positioning device rotates the pouring reservoir with respect to the reference plane to cause the liquid to flow into the freezing chamber.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a schematic illustration of a dispensing system for a liquid including a liquid distributor and a pouring reservoir positioned to receive a liquid from the liquid distributor;

FIG. 2 is an elevational right-side view of the dispensing system of FIG. 1 depicting a liquid reservoir having a tube connected to the liquid distributor;

FIG. 3 is a front elevational view of the dispensing system of FIG. 1 depicting a housing including a base;

FIG. 4 is a perspective view of the dispensing system of FIG. 1 depicting the liquid distributor positioned with the housing and a proximity sensor in communication with the pouring reservoir;

FIG. 5 is a top plan view of the dispensing system of FIG. 1 depicting the pouring reservoir positioned to receive the liquid from the liquid distributor and a freezing chamber positioned below the pouring reservoir;

FIG. 6 is a downward looking view of the liquid distributor of FIG. 1 including four chambers connected by a liquid channel and each including a pouring spout and a positioning device coupled to the liquid distributor;

FIG. 7 is a perspective view of the liquid distributor and the pouring reservoir of FIG. 1 and the positioning device of FIG. 6;

FIG. 8 is an elevational left-side view of the liquid distributor and the pouring reservoir of FIG. 1 including an overflow chamber and the positioning device of FIG. 6; and

FIG. 9 is a perspective view of the liquid distributor of FIG. 1.

### DETAILED DESCRIPTION

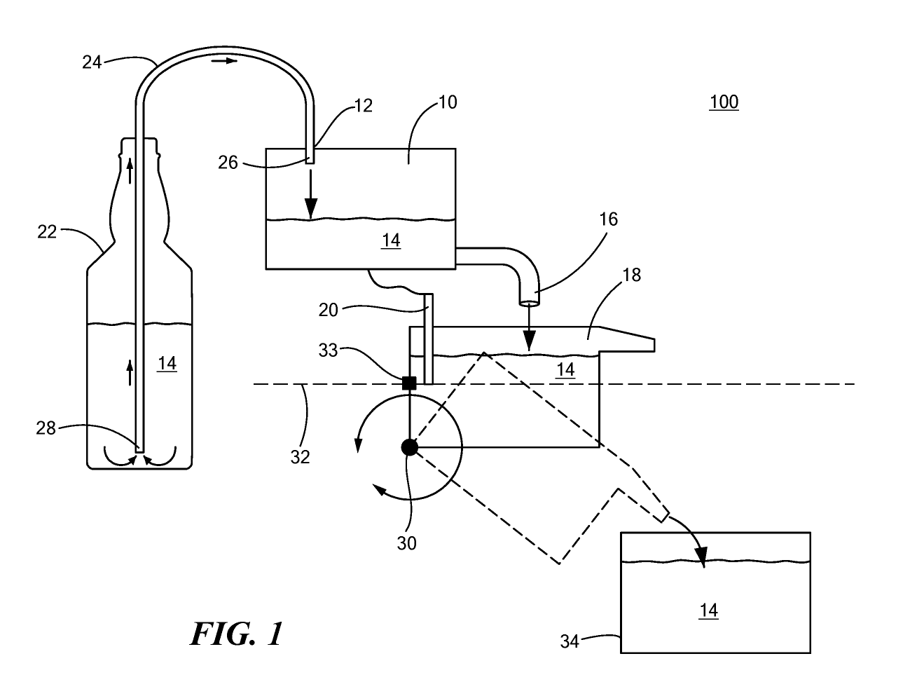

FIG. 1 is a schematic illustration of a dispensing system for a liquid 100 that is useful to understand the components and functions of the system. A liquid distributor 10 has an inlet 12 for receiving a liquid 14 and outlet 16 for dispensing the liquid 14. A pouring reservoir 18 is positioned to receive the liquid 14 from the outlet 16 of the liquid distributor 10. A sensor 20, such as a fill level sensor, is in communication with the liquid distributor 10 and the pouring reservoir 18 for determining a liquid fill level within the pouring reservoir 18.

Continuing to refer to FIG. 1, a liquid reservoir 22, such as an off-the-shelf bottle of an alcoholic beverage and/or a cocktail mixer, is in fluid communication with the inlet 12 of the liquid distributor 10. A pump (not shown) may actively cause liquid to flow from the liquid reservoir 22 to the liquid distributor 10. Alternatively, the liquid distributor 10 may be filled by hand pouring the liquid into the liquid distributor 10. Although the system can be configured to hold typical beverage bottles, such as 750 ml to 1,000 ml bottles, as is shown in subsequent figures, the system can be adapted to function with larger or smaller bottles or a liquid reservoir 22 or a group of reservoirs, each containing a different type of beverage. A tube 24 has a first end 26 that is connected to the inlet 12 of the liquid distributor 10 and a second end 28 that may be inserted into the liquid reservoir 22. The tube 24 can be flexible or rigid and can be metal or plastic or a combination of all of these choices.

The liquid distributor 10 is responsive to the sensor 20 to control an amount of liquid 14 dispensed from the outlet 16 of the liquid distributor in to the pouring reservoir 18. For example, the liquid distributor 10 dispenses the liquid 14 from the outlet 16 in response to a predetermined condition and stops dispensing liquid from the outlet 16 in response to a predetermined sensor input. The predetermined condition can include the press of a “start” button, or a time based signal, or a signal based on cycle frequency, or a signal based upon a “ready to fill” signal. In one embodiment, the sensor 20 is a continuity sensor having a pair of electrodes configured to close an electrical circuit when the liquid 14 comes in contact with the electrodes. A processor monitors the sensor 20 to determine when the circuit closes, thereby indicating that the liquid 14 has reached a predetermined level, further indicating that a predetermined amount of liquid has reached a predetermined fill level. For example, the fill level can correspond to one ounce of liquid. A sealed cover and an O-ring (not shown) may be provided to temporarily cover the pouring reservoir 18 to avoid a false fill indicator.

The liquid dispensing system 100 further includes a positioning device 30 for moving the pouring reservoir 18 with respect to a reference plane 32. In one embodiment, the reference plane 32 is established through the use of an electronic leveling circuit such as an accelerometer 33. The electronic leveling circuit allows the reference plane 32 to be established as a substantially horizontal plane transverse with respect to the outlet 16 to ensure that the sensor 20 will be triggered when the predetermined amount of liquid has been dispensed.

The electronic leveling circuit also allows an accurate determination of the amount of rotation by the positioning device 30 for the pouring reservoir 18. The positioning device 30 can include a motorized pivot or hinge that causes the pouring reservoir 18 to controllably rotate or pivot as indicated by the unnumbered curved arrow. The positioning device 30 can also cause translation of the pouring reservoir 18 in one of, or in a combination of, an x, y, and z axis as needed to position the pouring reservoir 18 in place to receive the liquid 14 from the outlet 16 and to position the pouring reservoir 18 in place for pouring the liquid 14 into a freezing chamber 34. In one embodiment, the pouring action is initiated when the sensor 20 indicates that the predetermined fill level of the liquid has been reached. When the pouring action has ceased and the pouring reservoir 18 is angled downward toward the freezing chamber 34, the processor may visually or audibly emit a signal representing a “non-level” position indicating that the pouring reservoir 18 is not level with the reference plane 32.

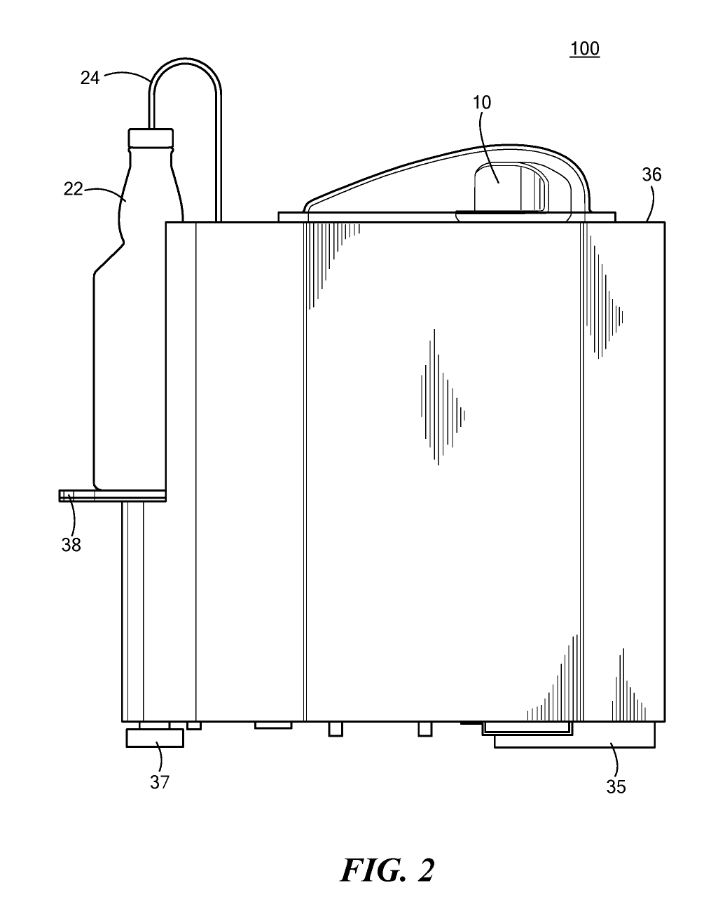

FIGS. 2-5 depict various views of the liquid dispensing system 100. In one configuration, as shown in FIG. 2, a bottle, e.g., a liquor bottle, serves as the liquid reservoir 22 and is easily mounted to a housing 36 on a “shelf” 38. The tube 24 is shown passing from the liquid reservoir 22 into the housing 36 and thence to the liquid distributor 10. The liquid reservoir 22 may also be disposed within the housing 36.

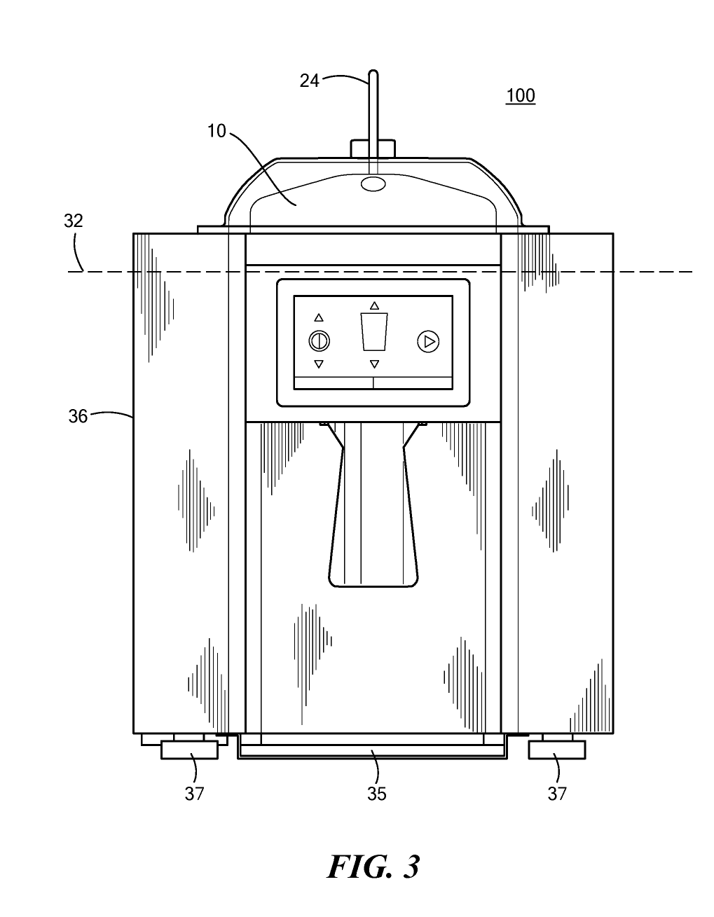

In an exemplary configuration, as shown in FIG. 3, the housing 36 includes a base 35 and two feet 37 which may be coupled to a motorized pivot or hinge that causes at least a portion of the housing 36 to controllably rotate or pivot as needed to position the pouring reservoir 18 with respect to the reference plane 32. With reference to FIGS. 1 and 3, the position of the pouring reservoir 18 assists to ensure that the sensor 20 will be triggered when the predetermined amount of liquid 14 has been dispensed into the pouring reservoir 18. The accelerometer 33 may compensate for adjustments in the position of the pouring reservoir 18 in conjunction with the base 35 and the pivot or hinge to ensure that the pouring reservoir 18 is positioned relative to the reference plane 32.

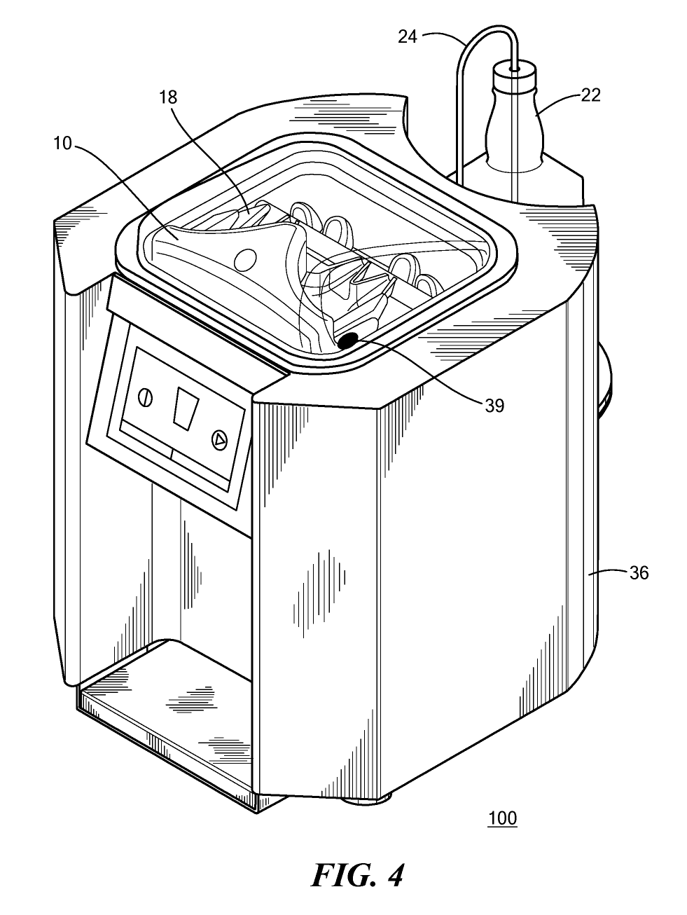

Moreover, in one exemplary embodiment, as illustrated in FIG. 4, the liquid distributor 10 may be in communication with an optical or other proximity sensor 39 to detect the proper positioning of the pouring reservoir 18, such as when the pouring reservoir 18 is parallel with respect to the reference plane 32 to receive the liquid 14. In one configuration, the liquid distributor 10 distributes the liquid 14 to the pouring reservoir 18 when the pouring reservoir 18 is indicated to be in the proper position by the proximity sensor 39.

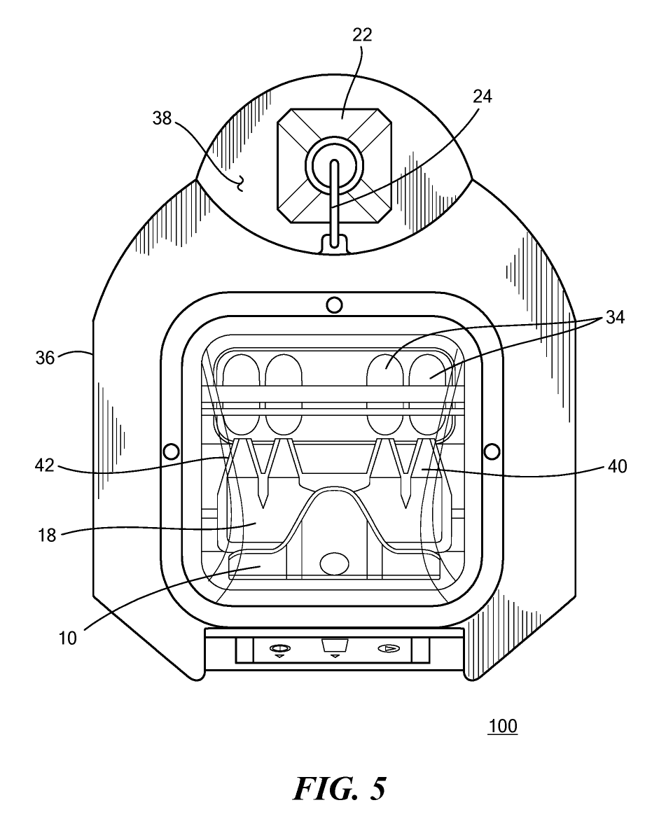

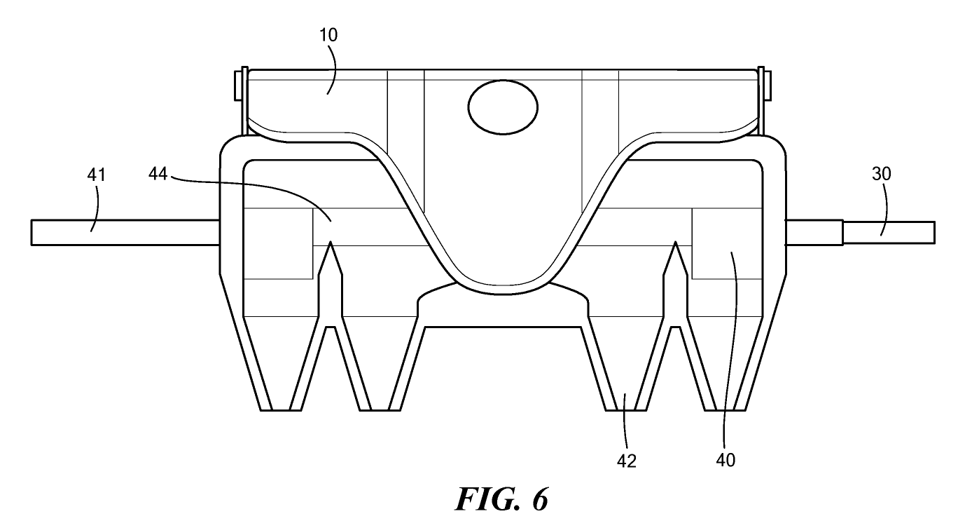

In FIG. 5, a top plan view of the housing 36 is shown depicting the pouring reservoir 18 subjacent the liquid distributor 10. In the illustrated embodiment, the pouring reservoir 18 includes four chambers 40, wherein each chamber is superjacent to four freezing chambers 34. More or less than four chambers 40 and four freezing chambers 34 may be utilized. With reference to FIGS. 5 and 6, the four chambers 40 of the pouring reservoir 18 include pouring ramps or spouts 42 that facilitate a clean and accurate pour when the pouring reservoir 18 is caused to rotate by a rod 41 that is connected to an actuator (not shown) within the housing 36. In one configuration, the pouring ramps or spouts 42 are cut at the tip to funnel the liquid 14 into the four freezing chambers 34 disposed below the pouring reservoir 18.

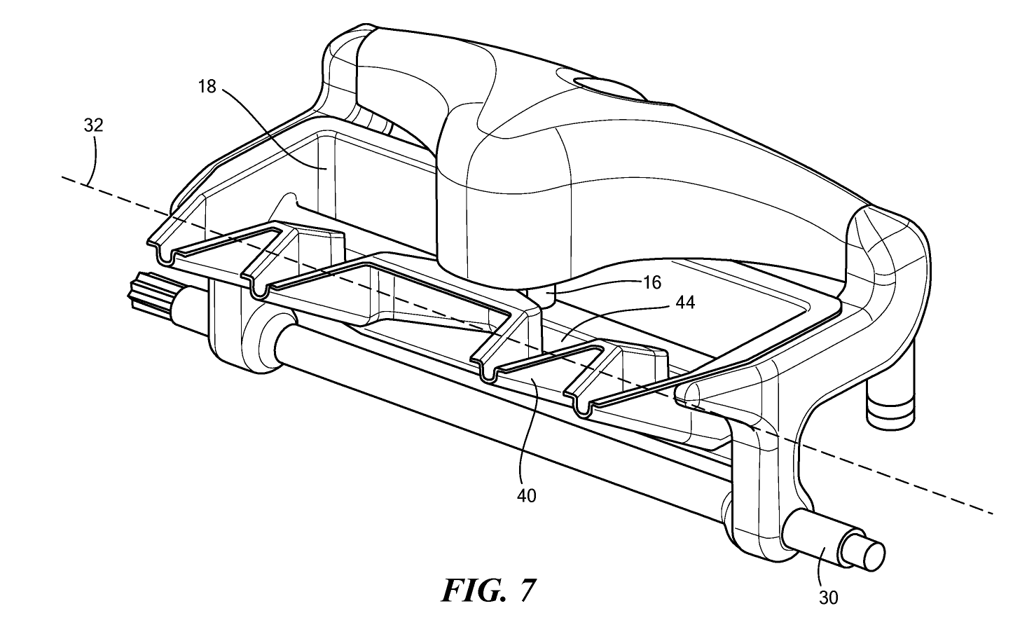

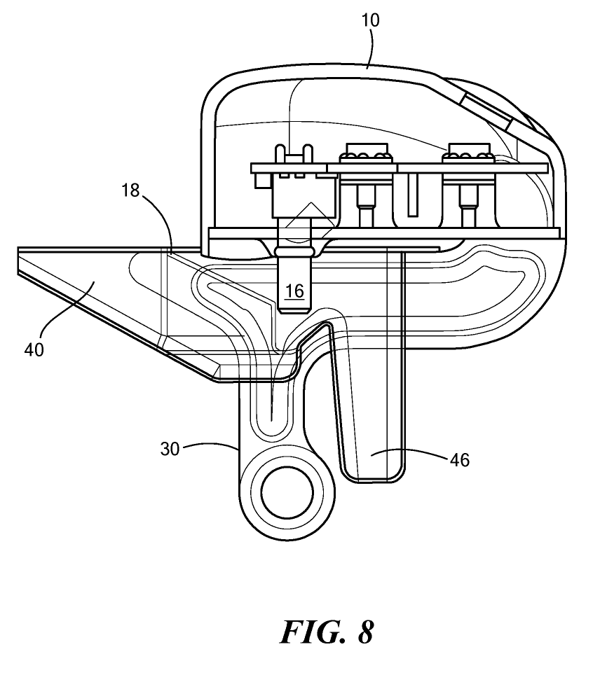

With reference to FIGS. 7-8, the chambers 40 are connected by a liquid flow channel 44 and the outlet 12 of the liquid distributor 10 is positioned to dispense the liquid into the liquid flow channel 44. By using the positioning device 30 to place the pouring reservoir 18 and the liquid flow channel 44 with respect to the reference plane 32, the positioning device 30 allows the liquid 14 to flow parallel to the reference plane 32 and uniformly into each of the reservoir chambers 40 to ensure that each is filled with the same volume of liquid 14. As best shown in the exemplary configuration of FIG. 8, if the reservoir chambers 40 are overfilled, excess liquid 14 can pass to an overflow chamber 46. The excess liquid 14 can be reused or discarded.

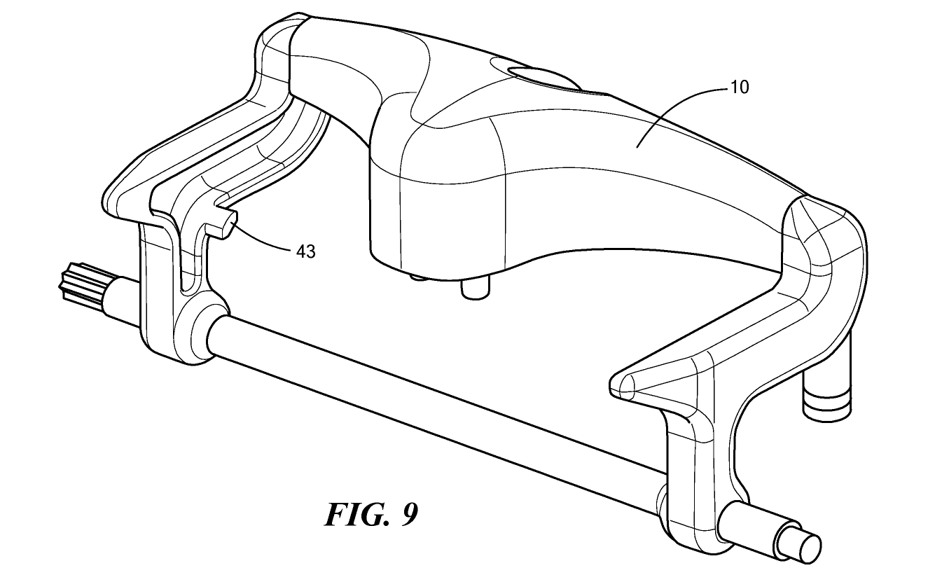

The reservoir chambers 40 are not limited to holding an equal volume of the liquid 14 and may be sized to accommodate different volumes of liquid 14 with respect to each other. In addition, the pouring reservoir 18 may be interchangeable. For example, as shown in FIG. 9, the liquid distributor 10 may include brackets 43 for releasably attaching different pouring reservoirs 18 thereto to accommodate various volumes of liquid 14.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A dispensing system for a liquid comprising:
a liquid distributor having an inlet for receiving the liquid and an outlet for dispensing the liquid;
a pouring reservoir positioned to receive the liquid from the outlet of the liquid distributor; and
a sensor in communication with the liquid distributor and the pouring reservoir for determining a liquid fill level within the pouring reservoir.

2. The dispensing system of claim 1, further comprising a liquid reservoir in fluid communication with the inlet of the liquid distributor.

3. The dispensing system of claim 2, wherein the liquid reservoir is a beverage bottle.

4. The dispensing system of claim 3, further comprising a tube having a first end that is connected to the inlet of the liquid distributor and a second end that is inserted into the beverage bottle.

5. The dispensing system of claim 1, wherein the liquid distributor is responsive to the sensor to control an amount of liquid dispensed from the outlet of the liquid distributor.

6. The dispensing system of claim 5, wherein the liquid distributor dispenses the liquid from the outlet in response to a predetermined condition and wherein the liquid distributor stops dispensing the liquid from the outlet in response to a predetermined sensor input.

7. The dispensing system of claim 1, further comprising a positioning device for moving the pouring reservoir with respect to a reference plane.

8. The dispensing system of claim 1, wherein the pouring reservoir comprises a plurality of chambers.

9. The dispensing system of claim 8, wherein the plurality of chambers are connected by a liquid flow channel.

10. The dispensing system of claim 9, wherein the outlet of the liquid distributor is positioned to dispense the liquid into the liquid flow channel.

11. The dispensing system of claim 10, wherein the reference plane is a horizontal plane and wherein the positioning device positions the pouring reservoir so that the liquid flow channel is parallel to the horizontal plane.

12. The dispensing system of claim 7, further comprising a freezing chamber disposed below the pouring reservoir.

13. The dispensing system of claim 12, wherein the positioning device rotates the pouring reservoir with respect to the reference plane to cause the liquid to flow into the freezing chamber.

14. The dispensing system of claim 1, wherein the sensor is a fill level indicator.

15. A dispensing system for a liquid comprising:
a liquid distributor having an outlet for dispensing the liquid;
a pouring reservoir positioned to receive the liquid from the outlet of the liquid distributor;
a sensor in communication with the pouring reservoir for determining a liquid fill level within the plurality of chambers of the pouring reservoir; and
a positioning device coupled to the pouring reservoir for rotating the pouring reservoir with respect to a reference plane.

16. The dispensing system of claim 15, further comprising an accelerometer for establishing the reference plane.

17. The dispensing system of claim 15, wherein the liquid distributor dispenses the liquid from the outlet in response to a predetermined condition and wherein the liquid distributor stops dispensing the liquid from the outlet in response to a predetermined sensor input.

18. The dispensing system of claim 15, further comprising a freezing chamber disposed below the pouring reservoir.

19. The dispensing system of claim 18, wherein the positioning device is in communication with the pouring reservoir for rotating the pouring reservoir with respect to the reference plane to cause the liquid to flow into the freezing chamber.

20. A dispensing system for a liquid comprising:
a liquid distributor having an inlet for receiving the liquid and outlet for dispensing the liquid;
a pouring reservoir comprising a plurality of chambers connected by a liquid flow channel positioned to receive the liquid from the outlet of the liquid distributor;
a sensor in communication with the liquid distributor and the pouring reservoir for determining a liquid fill level within the pouring reservoir;
a liquid reservoir in fluid communication with the inlet of the liquid distributor;
a tube having a first end that is connected to the inlet of the liquid distributor and a second end that is inserted into the beverage bottle;
a positioning device for moving the pouring reservoir with respect to a horizontal reference plane; and
a freezing chamber disposed below the pouring reservoir for receiving the liquid from the pouring reservoir when the positioning device rotates the pouring reservoir with respect to the reference plane to cause the liquid to flow into the freezing chamber.
